(19) United States
(12) Patent Application Publication
(10) Pub. No.: US 2017/0090927 A1
(43) Pub. Date: Mar. 30, 2017

(54) CONTROL TRANSFER INSTRUCTIONS INDICATING INTENT TO CALL OR RETURN

(71) Applicants: Paul Caprioli, Hillsboro, OR (US); KOICHI YAMADA, Los Gatos, CA (US); TUGRUL INCE, Santa Clara, CA (US)

(72) Inventors: Paul Caprioli, Hillsboro, OR (US); KOICHI YAMADA, Los Gatos, CA (US); TUGRUL INCE, Santa Clara, CA (US)

(21) Appl. No.: 14/870,417

(22) Filed: Sep. 30, 2015

(51) Int. Cl. G06F 9/30

(52) U.S. Cl. CPC G06F 9/30032

(57) ABSTRACT

Embodiments of an invention for control transfer instructions indicating intent to call or return are disclosed. In one embodiment, a processor includes a return target predictor, instruction hardware, and execution hardware. The instruction hardware is to receive a first instruction, a second instruction, and a third instruction, and the execution hardware to execute the first instruction, the second instruction, and the third instruction. Execution of the first instruction is to store a first return address on a stack and to transfer control to a first target address. Execution of the second instruction is to store a second return address in the return target predictor and transfer control to a second target address. Execution of the third instruction is to transfer control to the second target address.

### BACKGROUND

1. Field

The present disclosure pertains to the field of information processing, and more particularly, to the field of execution control transfers in information processing systems.

2. Description of Related Art

Information processing systems may provide for execution control to be transferred using an instruction (generally, a control transfer instruction or CTI). For example, a jump instruction (JMP) may be used to transfer control to an instruction other than the next sequential instruction. Similarly, a call instruction (CALL) may be used to transfer control to an entry point of a procedure or code sequence, where the procedure or code sequence includes a return instruction (RET) to transfer control back to the calling code sequence (or other procedure or code sequence). In connection with the execution of a CALL, the return address (e.g., the address of the instruction following the CALL in the calling procedure) may be stored in a data structure (e.g., a procedure stack). In connection with the execution of a RET, the return address may be retrieved from the data structure.

Processors having CTIs in their instruction set architecture (ISA) may include hardware to improve performance by predicting the target of a CTI. For example, processor hardware may predict the target of a RET based on information stored on the stack by the corresponding CALL, with a potential benefit in performance and power savings that is typically greater than that associated with predicting the target of a JMP.

### BRIEF DESCRIPTION OF THE FIGURES

The present invention is illustrated by way of example and not limitation in the accompanying figures.

FIG. 1 illustrates a system including support for control transfer instructions indicating intent to call or return according to an embodiment of the present invention.

FIG. 2 illustrates a processor including support for control transfer instructions indicating intent to call or return according to an embodiment of the present invention.

FIG. 3 illustrates a method for using control transfer instructions indicating intent to call or return according to an embodiment of the present invention.

FIG. 4 illustrates a representation of binary translation using control transfer instructions indicating intent to call or return according to an embodiment of the present invention.

### DETAILED DESCRIPTION

Embodiments of an invention for control transfer instructions indicating intent to call or return according to an embodiment of the present invention are described. In this description, numerous specific details, such as component and system configurations, may be set forth in order to provide a more thorough understanding of the present invention. It will be appreciated, however, by one skilled in the art, that the invention may be practiced without such specific details. Additionally, some well-known structures, circuits, and other features have not been shown in detail, to avoid unnecessarily obscuring the present invention.

In the following description, references to “one embodiment,” “an embodiment,” “example embodiment,” “various embodiments,” etc., indicate that the embodiment(s) of the invention so described may include particular features, structures, or characteristics, but more than one embodiment may and not every embodiment necessarily does include the particular features, structures, or characteristics. Further, some embodiments may have some, all, or none of the features described for other embodiments.

As used in this description and the claims and unless otherwise specified, the use of the ordinal adjectives “first,” “second,” “third,” etc. to describe an element merely indicate that a particular instance of an element or different instances of like elements are being referred to, and is not intended to imply that the elements so described must be in a particular sequence, either temporally, spatially, in ranking, or in any other manner.

Also, as used in descriptions of embodiments of the present invention, a “/” character between terms may mean that an embodiment may include or be implemented using, with, and/or according to the first term and/or the second term (and/or any other additional terms).

As described in the background section, processors having CTIs in their ISA may include hardware to improve performance by predicting the target of RETs based on information stored on the stack by corresponding CALLs. However, the use of this hardware may be ineffective if binary translation is used to convert code using CALLs and RETs because the return address associated with the CALL in the untranslated code would not correspond to the proper return address to be used in the translated code. Therefore, translation of a CALL typically includes pushing (using a PUSH instruction, as described below) the return address associated with the CALL onto the stack and using a JMP to emulate the control transfer of the CALL, so that the return address of the original CALL is pushed onto the program's stack (the stack should hold the address associated with the untranslated code because it is readable by the program) while control transfer is effected to the translated code location. Similarly, translation of a RET typically involves popping (using a POP instruction, as described below) the return address associated with the CALL in the untranslated code from the stack, using it to determine a new return address corresponding to the translated code, and then using a JMP with the new return address to emulate the control transfer of the RET. According to this approach, JMPs, CALLs, and RETs are all translated to JMPs, without the potential benefit of stack-based hardware RET target prediction. Therefore, the use of embodiments of the present invention may be desired to provide the potential benefits (e.g., higher performance and lower power consumption) of stack-based RET target prediction in code that has been generated through binary translation.

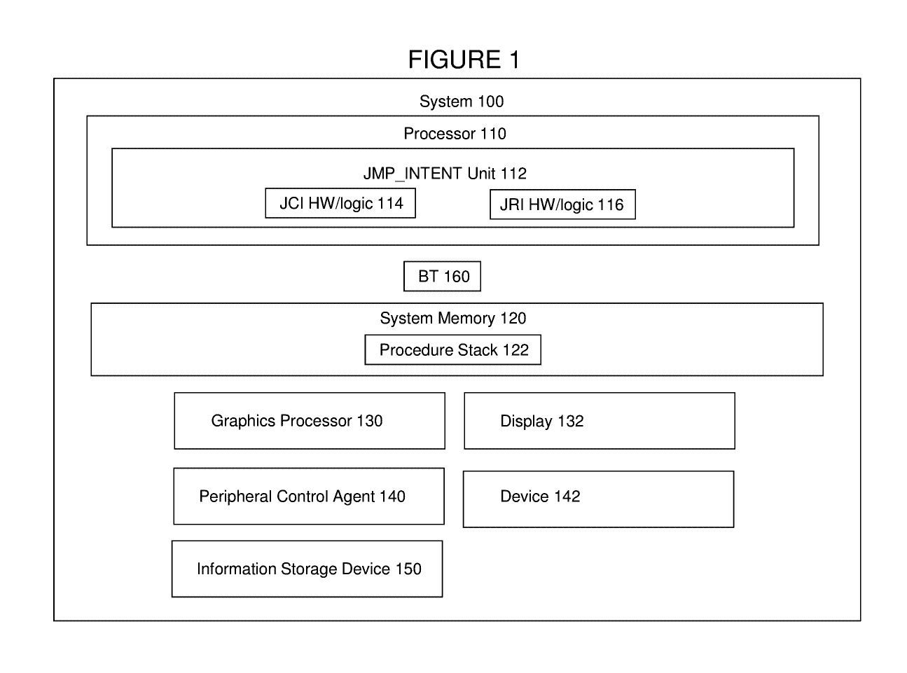

FIG. 1 illustrates system 100, an information processing system including support for control transfer instructions indicating intent to call or return according to an embodiment of the present invention. System 100 may represent any type of information processing system, such as a server, a desktop computer, a portable computer, a set-top box, a hand-held device such as a tablet or a smart phone, or an embedded control system. System 100 includes processor 110, system memory 120, graphics processor 130, peripheral control agent 140, and information storage device 150. Systems embodying the present invention may include any number of each of these components and any other components or other elements, such as peripherals and input/output devices. Any or all of the components or other elements in this or any system embodiment may be connected, coupled, or otherwise in communication with each other through any number of buses, point-to-point, or other wired or wireless interfaces or connections, unless specified otherwise. Any components or other portions of system 100, whether shown in FIG. 1 or not shown in FIG. 1, may be integrated or otherwise included on or in a single chip (a system-on-a-chip or SOC), die, substrate, or package.

System memory 120 may be dynamic random access memory or any other type of medium readable by processor 110. System memory 120 may be used to store procedure stack 122. Graphics processor 130 may include any processor or other component for processing graphics data for display 132. Peripheral control agent 140 may represent any component, such as a chipset component, including or through which peripheral, input/output (I/O), or other components or devices, such as device 142 (e.g., a touchscreen, keyboard, microphone, speaker, other audio device, camera, video or other media device, network adapter, motion or other sensor, receiver for global positioning or other information, etc.) and/or information storage device 150, may be connected or coupled to processor 110. Information storage device 150 may include any type of persistent or non-volatile memory or storage, such as a flash memory and/or a solid state, magnetic, or optical disk drive.

Processor 110 may represent one or more processors or processor cores integrated on a single substrate or packaged within a single package, each of which may include multiple threads and/or multiple execution cores, in any combination. Each processor represented as or in processor 110 may be any type of processor, including a general purpose microprocessor, such as a processor in the Intel® Core® Processor Family or other processor family from Intel® Corporation or another company, a special purpose processor or microcontroller, or any other device or component in an information processing system in which an embodiment of the present invention may be implemented.

Support for control transfer instructions indicating intent to call or return according to an embodiment of the present invention may be implemented in a processor, such as processor 110, using any combination of circuitry and/or logic embedded in hardware, microcode, firmware, and/or other structures arranged as described below or according to any other approach, and is represented in FIG. 1 as JMP_INTENT unit 112, which may include JCI hardware/logic 114 to support a JMP_CALL_INTENT instruction and JRI hardware/logic 116 to support a JMP_RETURN_INTENT instruction, each according to embodiments of the present invention as described below.

FIG. 1 also shows binary translator (BT) 160, which may represent any hardware (e.g., within processor 110), microcode (e.g., within processor 110), firmware, or software (e.g., within system memory 120 and/or memory within processor 110) for translating binary code of one ISA to binary code of another ISA, for example, translating binary code of an ISA other than that of processor 110 to the ISA of processor 110.

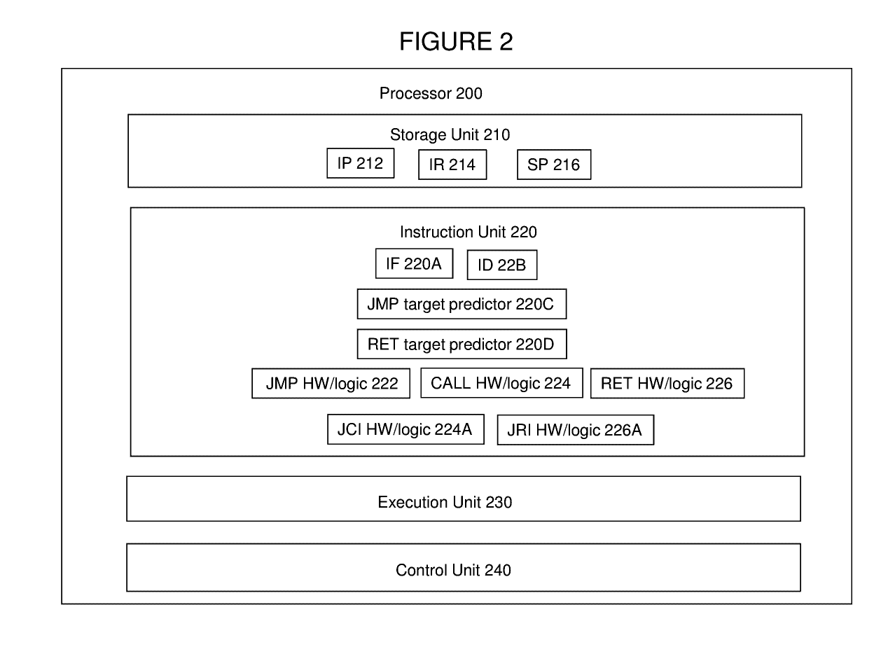

FIG. 2 illustrates processor 200, which may represent an embodiment of processor 110 in FIG. 1 or an execution core of a multicore processor embodiment of processor 110 in FIG. 1. Processor 200 may include storage unit 210, instruction unit 220, execution unit 230, and control unit 240. Each such unit is shown as a single unit for convenience; however, the circuitry of each such unit may be combined within and/or distributed throughout processor 200 according to any approach. For example, various portions of hardware/logic corresponding to JMP/INTENT unit 112 of processor 110 may be physically integrated into storage unit 210, instruction unit 220, execution unit 230, and/or control unit 240, for example, as may be described below. Processor 200 may also include any other circuitry, structures, or logic not shown in FIG. 1.

Storage unit 210 may include any combination of any type of storage usable for any purpose within processor 200; for example, it may include any number of readable, writable, and/or read-writable registers, buffers, and/or caches, implemented using any memory or storage technology, in which to store capability information, configuration information, control information, status information, performance information, instructions, data, and any other information usable in the operation of processor 200, as well as circuitry usable to access such storage and/or to cause or support various operations and/or configurations associated with access to such storage.

In an embodiment, storage unit 210 may include instruction pointer (IP) register 212, instruction register (IR) 214, and stack pointer (SP) register 216. Each of IP register 212, IR 214, and SP register 216 may represent one or more registers or portions of one or more registers or other storage locations, but for convenience may be referred to simply as a register.

IP register 212 may be used to hold an IP or other information to directly or indirectly indicate the address or other location of an instruction currently being scheduled, decoded, executed, or otherwise handled; to be scheduled, decoded, executed, or otherwise handled immediately after the instruction currently being scheduled, decoded, executed, or otherwise handled (the “current instruction”), or to be scheduled, decoded, executed, or otherwise handled at a specified point (e.g., a specified number of instructions after the current instruction) in a stream of instructions. IP register 212 may be loaded according to any known instruction sequencing technique, such as through the advancement of an IP or through the use of a CTI.

IR 214 may be used to hold the current instruction and/or any other instruction(s) at a specified point in an instruction stream relative to the current instruction. IR 214 may be loaded according to any known instruction fetch technique, such as by an instruction fetch from the location in system memory 120 specified by an IP.

SP register 216 may be used to store a pointer or other reference to a procedure stack upon which return addresses for control transfers may be stored. In an embodiment, the stack may be implemented as a linear array following a “last in-first out” (LIFO) access paradigm. The stack may be in a system memory such as system memory 120, as represented by procedure stack 122 of FIG. 1. In other embodiments, a processor may be implemented without a stack pointer, for example, in an embodiment in which a procedure stack is stored in internal memory of the processor.

Instruction unit 220 may include any circuitry, logic, structures, and/or other hardware, such as an instruction decoder, to fetch, receive, decode, interpret, schedule, and/or handle instructions to be executed by processor 200. Any instruction format may be used within the scope of the present invention; for example, an instruction may include an opcode and one or more operands, where the opcode may be decoded into one or more micro-instructions or micro-operations for execution by execution unit 230. Operands or other parameters may be associated with an instruction implicitly, directly, indirectly, or according to any other approach.

In an embodiment, instruction unit 220 may include instruction fetcher (IF) 220A and instruction decoder (ID) 220B. IF 220A may represent circuitry and/or other hardware to perform and/or control the fetching of instructions from locations specified by IPs and the loading of instructions into IR 214. ID 220B may represent circuitry and/or other hardware to decode instructions in IR 214. IF 220A and ID 220B may be designed to perform instruction fetch and instruction decode as front-end stages in an instruction execution pipeline. The front-end of the pipeline may also include JMP target predictor 220C, which may represent hardware to predict the target of a JMP instruction (not based on information stored on the stack), and RET target predictor 220D, which may represent hardware to predict the target of a RET instruction based on information stored on the stack.

Instruction unit 220 may be designed to receive instructions to support control flow transfers. For example, instruction unit 220 may include JMP hardware/logic 222, CALL hardware/logic 224, and RET hardware/logic 226, to receive jump, call, and return instructions, respectively, as described above in the background section and/or as known in the art.

Instruction unit 220 may also include JCI hardware/logic 224A, which may correspond to JCI hardware/logic 114 of processor 110, and JRI hardware/logic 226A, which may correspond to JRI hardware/logic 116 of processor 110, to receive a JMP_CALL_INTENT and JMP_RET_INTENT instructions, respectively, according to embodiments of the present invention as described below. In various embodiments, JMP_CALL_INTENTs (instead of JMPs) may be used by binary translators in connection with converting CALLs, and JUMP_RET_INTENTs (instead of JMPs) may be used by binary translators in connection with converting RETs, as further described below. In various embodiments, JMP_CALL_INTENT and JMP_RET_INTENT instructions may have distinct opcodes or be leaves of the opcode for another instruction, such as JMP, where the leaf instructions may be specified by a prefix or other annotation or operand associated with the other instruction's opcode.

Instruction unit 220 may also be designed to receive instructions to access the stack. In an embodiment, the stack grows towards lesser memory addresses. Data items may be placed on the stack using a PUSH instruction and retrieved from the stack using a POP instruction. To place a data item on the stack, processor 200 may modify (e.g., decrement) the value of a stack pointer and then copy the data item into the memory location referenced by the stack pointer. Hence, the stack pointer always references the top-most element of the stack. To retrieve a data item from the stack, processor 200 may read the data item referenced by the stack pointer, and then modify (e.g., increment) the value of the stack pointer so that it references the element which was placed on the stack immediately before the element that is being retrieved.

As introduced above, execution of a CALL may include pushing the return address onto the stack. Accordingly, processor 200 may, prior to branching to the entry point in the called procedure, push the address stored in an IP register onto the stack. This address, also referred to as the return instruction pointer, points to the instruction where execution of the calling procedure should resume following a return from the called procedure. When executing a return instruction within the called procedure, processor 200 may retrieve the return instruction pointer from the stack back into the instruction pointer register, and thus resume execution of the calling procedure.

However, processor 200 may not require that the return instruction pointer point back to the calling procedure. Prior to executing the return instruction, the return instruction pointer stored in the stack may be manipulated by software (e.g., by executing a PUSH instruction) to point to an address other than the address of the instruction following the call instruction in the calling procedure. Manipulation of the return instruction pointer may be allowed by processor 200 to support a flexible programming model.

Execution unit 230 may include any circuitry, logic, structures, and/or other hardware, such as arithmetic units, logic units, floating point units, shifters, etc., to process data and execute instructions, micro-instructions, and/or micro-operations. Execution unit 230 may represent any one or more physically or logically distinct execution units.

Execution of a JMP_CALL_INTENT instruction may include storing a return address in a return address buffer, shadow stack, or other data structure within or used by a hardware RET target predictor (e.g., RET target predictor 220D). In an embodiment, the return address to be stored may be that of the instruction immediately following the JMP_CALL_INTENT. In an embodiment, an operand of the JMP_CALL_INTENT instruction may specify the return address to be stored, thus providing more flexibility for binary translators to place translated RET targets.

Note that a difference between a JMP_CALL_INTENT and a JMP is that a JMP does not include the storing of a return address for a RET target predictor. Therefore, the use of a JMP_CALL_INTENT (instead of a JMP) by a binary translator may provide the benefits of RET target prediction. Another difference between a JMP_CALL_INTENT and a JMP is that a JMP_CALL_INTENT optionally may not attempt the use (and therefore not pollute) a hardware JMP target predictor (e.g. JMP target predictor 220C) that may be provided for improving the performance of JMP instructions. Also note that a difference between a JMP_CALL_INTENT and a CALL is that a CALL stores its return address on the stack, whereas a JMP_CALL_INTENT does not.

Execution of a JMP_RET_INTENT instruction may include retrieving a return address from a return address buffer, shadow stack, or other data structure within or used by a hardware RET target predictor (e.g., RET target predictor 220D). Note that a difference between a JMP_RET_INTENT and a JMP is that a JMP does not include the retrieving of a return address from a RET target predictor. Therefore, the use of a JMP_RET_INTENT (instead of a JMP) by a binary translator may provide the benefits of RET target prediction. Another difference between a JMP_RET_INTENT and a JMP is that a JMP_RET_INTENT does not attempt the use (and therefore does not pollute) a hardware JMP target predictor (e.g., JMP target predictor 220C) that may be provided for improving the performance of JMP instructions.

Control unit 240 may include any microcode, firmware, circuitry, logic, structures, and/or hardware to control the operation of the units and other elements of processor 200 and the transfer of data within, into, and out of processor 200. Control unit 240 may cause processor 200 to perform or participate in the performance of method embodiments of the present invention, such as the method embodiment(s) described below, for example, by causing processor 200, using execution unit 230 and/or any other resources, to execute instructions received by instruction unit 220 and micro-instructions or micro-operations derived from instructions received by instruction unit 220. The execution of instructions by execution 230 may vary based on control and/or configuration information in storage unit 210.

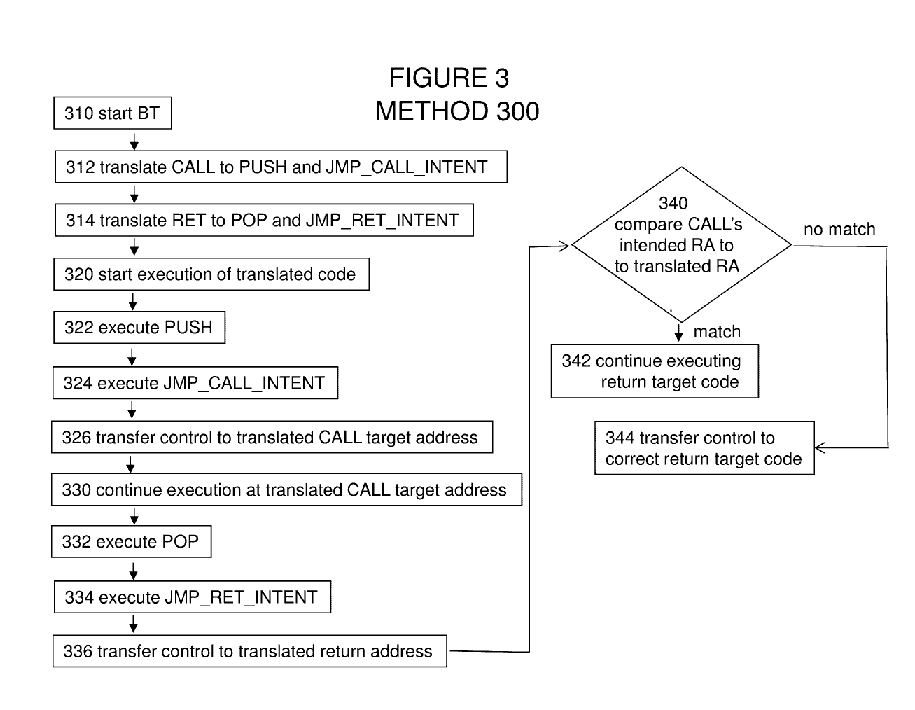

FIG. 3 illustrates method 300 for using control transfer instructions indicating intent to call or return according to an embodiment of the present invention. Although method embodiments of the invention are not limited in this respect, reference may be made to elements of FIGS. 1 and 2 to help describe the method embodiment of FIG. 3. Various portions of method 300 may be performed by hardware, firmware, software, and/or a user of a system or device.

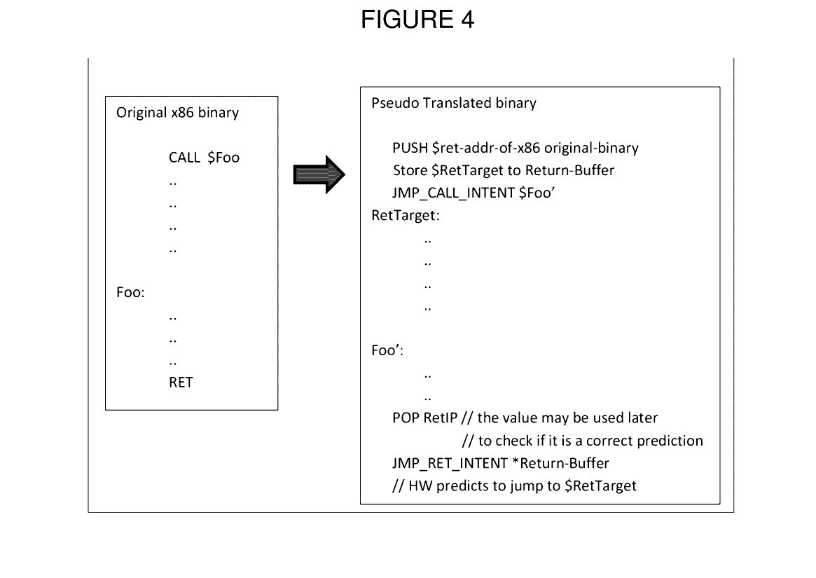

In box 310 of method 300, a binary translator (e.g., BT 160) may begin translation of a binary code sequence including a CALL and a RET. The translation of one such sequence is illustrated in pseudo-code in FIG. 4. In box 312, the CALL may be converted to a PUSH and a JMP_CALL_INTENT, where the PUSH may be used to store the CALL's intended return address onto a stack (e.g., stack 122), and where the binary translator converts the target address of the CALL to a translated target address for the JMP_CALL_INTENT (the translated CALL target address). In box 314, the RET may be converted to a POP and a JMP_RET_INTENT, where the POP may be used to retrieve the CALL's intended return address from the stack.

In box 320, execution of the translated code by a processor (e.g., processor 110) may begin. In box 322, execution of the PUSH may store the CALL's intended return address on the stack.

In box 324, execution of the JMP_CALL_INTENT may include storing the translated return address in a hardware RET target predictor (e.g. RET target predictor 220D). In an embodiment, the address immediately following the JMP_CALL_INTENT may be used as the translated return address. In another embodiment, the translated return address may be supplied by or derived from an operand of the JMP_CALL_INTENT, where the operand may have been supplied by the binary translator based on its conversion of the original binary code sequence. In box 326, execution of the JMP_CALL_INTENT may include transferring control to the translated CALL target address.

In box 330, execution may continue at the translated CALL target address. In box 332, execution of the POP may retrieve the CALL's intended return address from the stack.

In box 334, execution of the JMP_RET_INTENT may include retrieving the translated return address from a hardware RET target predictor (e.g. RET target predictor 220D). In box 336, execution of the JMP_RET_INTENT may include transferring control to the translated return address.

In box 340, the CALL's intended return address, as retrieved in box 332, may be compared to the translated return address. If there is a match, then in box 342, the processor continues to execute the code starting with the translated return address (the return target code). If not, then method 300 continues in box 344.

In box 344, program flow may be corrected according to any of a variety of approaches. In an embodiment, control may be transferred to fix-up or other code to find an entry point into the correct target code, for example by searching a table or other data structure, maintained by the translator, containing original code addresses and their corresponding translated code addresses. The transfer of control to the fix-up or other such code may be accomplished with a CTI, an exception, etc. Accomplishing this transfer of control may also stop the execution of the incorrect return target code before any results have been committed, e.g., by flushing the processor's instruction execution pipeline.

In various embodiments of the present invention, the method illustrated in FIG. 3 may be performed in a different order, with illustrated boxes combined or omitted, with additional boxes added, or with a combination of reordered, combined, omitted, or additional boxes.

Furthermore, method embodiments of the present invention are not limited to method 300 or variations thereof. Many other method embodiments (as well as apparatus, system, and other embodiments) not described herein are possible within the scope of the present invention.

Embodiments or portions of embodiments of the present invention, as described above, may be stored on any form of intangible or tangible machine-readable medium. For example, all or part of method 300 may be embodied in software or firmware instructions that are stored on a tangible medium readable by processor 110, which when executed by processor 110, cause processor 110 to execute an embodiment of the present invention. Also, aspects of the present invention may be embodied in data stored on a tangible or intangible machine-readable medium, where the data represents a design or other information usable to fabricate all or part of processor 110.

Thus, embodiments of an invention for control transfer instructions indicating intent to call or return have been described. While certain embodiments have been described, and shown in the accompanying drawings, it is to be understood that such embodiments are merely illustrative and not restrictive of the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

What is claimed is:

1. A processor comprising:
a return target predictor;
instruction hardware to receive a first instruction, a second instruction, and a third instruction; and
execution hardware to execute the first instruction, the second instruction, and the third instruction, wherein
execution of the first instruction is to store a first return address on a stack and to transfer control to a first target address,
execution of the second instruction is to store a second return address in the return target predictor and transfer control to a second target address, and
execution of the third instruction is to transfer control to the second target address.

2. The processor of claim 1, wherein execution of the second instruction is to store the second return address in the return target predictor and transfer control to the second target address without storing the first return address on the stack and without storing the second return address on the stack.

3. The processor of claim 2, wherein execution of the third instruction is to transfer control to the second target address without storing the first return address in the return target predictor, without storing the second return address in the return target predictor, without storing the first return address on the stack, and without storing the second return address on the stack.

4. The processor of claim 1, wherein:
the instruction hardware is also to receive a fourth instruction and a fifth instruction; and
the execution hardware is also to execute the fourth instruction and the fifth instruction, wherein
execution of the fourth instruction is to retrieve the first return address from the stack and to transfer control to the first return address, and
execution of the fifth instruction is to retrieve the second return address from the return target predictor and transfer control to the second return address.

5. The processor of claim 4, wherein execution of the fifth instruction is to retrieve the second return address from the return target predictor and transfer control to the second return address without retrieving the first return address from the stack and without retrieving the second return address from the stack.

6. The processor of claim 1, wherein the second target address is to be derived from the first target address in connection with binary translation.

7. The processor of claim 1, wherein the second return address is to be derived from an operand of the second instruction.

8. A method comprising:
translating a call instruction to a push instruction and a first instruction, wherein the call instruction is to store a first return address on a stack and to transfer control to a first target address;
executing, by a processor, the push instruction to store the first return address on the stack; and
executing, by the processor, the first instruction, wherein execution of the first instruction includes storing a second return address in a return target predictor and transferring control to a second target address.

9. The method of claim 8, wherein execution of the first instruction includes storing the second return address in the return target predictor and transferring control to the second target address without storing the first return address on the stack and without storing the second return address on the stack.

10. The method of claim 8, further comprising:
translating a return instruction to a second instruction, wherein the return instruction is to retrieve the first return address from the stack and to transfer control to the first return address; and
executing, by the processor, the second instruction, wherein execution of the second instruction includes retrieving the second return address from the return target predictor and transferring control to the second return address.

11. The method of claim 10,
wherein translating the return instruction to the second instruction includes translating the return instruction to a pop instruction and the second instruction, further comprising:
executing, by the processor, the pop instruction to retrieve the first return address from the stack.

12. The method of claim 10, wherein execution of the second instruction includes retrieving the second return address from the return target predictor and transferring control to the second return address without retrieving the first return address from the stack and without retrieving the second return address from the stack.

13. The method of claim 8, wherein translating also includes deriving the second target address from the first target address.

14. The method of claim 8, further comprising deriving the second return address from an operand of the first instruction.

15. The method of claim 11, further comprising:
comparing the first return address retrieved by the pop instruction with the second return address retrieved by the second instruction; and
if the comparing results in a mismatch, transferring control from return target code for which the second return address is an entry point.

16. A system, comprising:
a binary translator to translate first binary code to second binary code, the first binary code including a call instruction to store a first return address on a stack and to transfer control to a first target address, the binary translator to translate the call instruction to a push instruction and a first instruction; and
a processor, including:
a return target predictor;
instruction hardware to receive the push instruction and the first instruction; and
execution hardware to execute the push instruction and the first instruction, wherein
execution of the push instruction is to store the first return address on the stack, and
execution of the first instruction is to store a second return address in the return target predictor and transfer control to a second target address.

17. The system of claim 16, further comprising a system memory in which to store the stack.

18. The system of claim 16, wherein execution of the first instruction is to store the second return address in the return target predictor and transfer control to the second target address without storing the first return address on the stack and without storing the second return address on the stack.

19. The system of claim 16, wherein:
the first binary code also includes a return instruction to retrieve the first return address from the stack and to transfer control to the first return address, the binary translator to translate the return instruction to a second instruction; and
the processor also includes:
instruction hardware to receive the second instruction; and
execution hardware to execute the second instruction, wherein
execution of the second instruction is to retrieve the second return address from the return target predictor and transfer control to the second return address.

20. The system of claim 19, wherein execution of the second instruction is to retrieve the second return address from the return target predictor and transfer control to the second return address without retrieving the first return address from the stack and without retrieving the second return address from the stack.
